(19) United States
(12) Patent Application Publication
(10) Pub. No.: US 2025/0273682 A1
(43) Pub. Date: Aug. 28, 2025

(54) BINDER FOR ELECTRICITY STORAGE DEVICE, BINDER SOLUTION FOR ELECTRICITY STORAGE DEVICE, ELECTRODE SLURRY FOR ELECTRICITY STORAGE DEVICE, ELECTRODE FOR ELECTRICITY STORAGE DEVICE, AND ELECTRICITY STORAGE DEVICE

(71) Applicant: Kuraray Co., Ltd., Okayama (JP)

(72) Inventors: Kengo TACHIKAWA, Kurashiki-shi, Okayama (JP); Momotaro KANNO, Kurashiki-shi, Okayama (JP); Shinsuke NII, Kurashiki-shi, Okayama (JP); Kenta KURASHIMA, Kurashiki-shi, Okayama (JP)

(73) Assignee: Kuraray Co., Ltd., Okayama (JP)

(21) Appl. No.: 18/706,201

(22) PCT Filed: Nov. 1, 2022
(86) PCT No.: PCT/JP2022/040885

§ 371 Date: Oct. 4, 2024

(30) Foreign Application Priority Data
Nov. 1, 2021 (JP) 2021-178825

(51) Int. Cl. H01M 4/62; C08F 216/06; C09D 5/24; C09D 129/04; H01G 11/28; H01G 11/30

(52) U.S. Cl. CPC H01M 4/622; C08F 216/06; C09D 5/24; C09D 129/04; H01G 11/28; H01G 11/30

(57) ABSTRACT

Provided is a binder for an electricity storage device, the binder being superior in peel strength in a case of being used in an electrode and being suitable for obtaining an electrode having low resistance. Further provided are a binder solution for an electricity storage device, an electrode slurry for an electricity storage device, an electrode for an electricity storage device, and an electricity storage device. The binder for an electricity storage device contains a modified vinyl alcohol polymer, wherein the modified vinyl alcohol polymer has: a content of a structural unit derived from an ethylenic unsaturated dicarboxylic acid derivative (A) being 0.05 mol % or more and 10 mol % or less, a degree of saponification of 70.0 mol % or more and 99.9 mol % or less, and an amount of insoluble content being 0.1 ppm or more and less than 2,000 ppm, when the modified vinyl alcohol polymer is prepared into an aqueous solution at 90° C. having a concentration of 5% by mass.

### TECHNICAL FIELD

The present disclosure relates to a binder for an electricity storage device, a binder solution for an electricity storage device, an electrode slurry for an electricity storage device, an electrode for an electricity storage device, and an electricity storage device.

### BACKGROUND ART

In recent years, mobile terminals such as cellular phones, laptop personal computers, and pad-type information terminal devices have become remarkably widespread. There is a demand for mobile terminals to be more comfortably portable and, with the rapid progress of size reduction, thickness reduction, weight reduction, and performance enhancement, batteries used in such mobile terminals are also required to be reduced in size, thickness, and weight, and provided with enhanced performance. As electricity storage devices used as power sources of such mobile terminals, lithium ion secondary batteries are selected in many cases. Electricity storage devices such as lithium ion secondary batteries have a structure in which positive electrodes and negative electrodes are arranged via a separator and housed in a container together with an electrolyte solution containing a lithium salt such as LiPF₆, LiBF₄, LiTFSI (lithium bis(trifluoromethylsulfonyl)imide), or LiFSI (lithium bis(fluorosulfonyl)imide) dissolved in an organic liquid such as ethylene carbonate.

A negative electrode and a positive electrode that constitute an electricity storage device are typically formed by applying an electrode slurry, being obtained by dissolving or dispersing a binder and a thickening agent into water or a solvent and mixing the resultant with an active material, a conductive aid (conductivity-imparting agent), and/or the like, onto a current collector, and subsequently drying the water or solvent to permit binding as a mixed layer.

In light of reducing the environmental burden and the convenience of manufacturing equipment, especially in production of negative electrodes, the transition to electrode slurries in which an aqueous medium is used is rapidly progressing. As a binder for such an aqueous medium, binders such as a vinyl alcohol polymer, an acrylic polymer such as acrylic acid, an amide/imide polymer, and the like are known (see, for example, Patent Documents 1 and 2).

On the other hand, in production of positive electrodes, an electrode slurry using a solvent is generally used. Examples of such a solvent include organic solvents such as N-methyl-2-pyrrolidone, dimethylformamide, N,N-dimethylacetamide, N,N-dimethylmethanesulfonamide, and hexamethylphosphoric triamide. As a binder for such organic solvents, a vinylidene fluoride polymer, a tetrafluoroethylene polymer, fluororubber, or the like can be used (see, for example, Patent Documents 3 and 4).

### PRIOR ART DOCUMENTS

### Patent Documents

Patent Document 1: Japanese Unexamined Patent Application, Publication No. H11-250915
Patent Document 2: Japanese Unexamined Patent Application, Publication No. 2017-59527
Patent Document 3: Japanese Unexamined Patent Application, Publication No. 2017-107827
Patent Document 4: Japanese Unexamined Patent Application, Publication No. 2013-37955

### SUMMARY OF THE INVENTION

### Problems to be Solved by the Invention

In order to meet the demand for further size reduction, thickness reduction, weight reduction, and the like of electricity storage devices, both negative electrodes and positive electrodes are required to have an improved energy density. Accordingly, there is increasing demand for an electrode in which the amount of a binder is reduced while the amount of an active material is increased. Thus, there is a requirement for an electrode having high peel strength that can inhibit flaking at the time of being cut, even when having a composition containing only a small amount of a binder.

Further, due to a demand for reducing the charging time, there is a requirement for a battery in which a decrease in the capacity is inhibited even when the battery is rapidly charged as opposed to when the battery is slowly charged. An energy loss associated with the internal resistance is believed to be the main cause of a decrease in the capacity during rapid charging: therefore, there is a demand for a low-resistance electrode.

In view of the foregoing problems, it is an object of the present disclosure to provide a binder for an electricity storage device, the binder being superior in peel strength in a case of being used in an electrode and being suitable for obtaining an electrode having low resistance, and it is also an object to provide a binder solution for an electricity storage device, an electrode slurry for an electricity storage device, an electrode for an electricity storage device, and an electricity storage device.

### Means for Solving the Problems

As a result of intensive investigation, the present inventors have found that the aforementioned problems can be solved by means of a binder for an electricity storage device, the binder containing a certain modified vinyl alcohol polymer.

Specifically, the present invention encompasses the following subject-matter.
(1) A binder for an electricity storage device, the binder containing a modified vinyl alcohol polymer,
   wherein the modified vinyl alcohol polymer has:
      a content of a structural unit derived from an ethylenic unsaturated dicarboxylic acid derivative (A) being 0.05 mol % or more and 10 mol % or less,
      a degree of saponification of 70.0 mol % or more and 99.9 mol % or less, and
      an amount of insoluble content being 0.1 ppm or more and less than 2,000 ppm, when the modified vinyl alcohol polymer is prepared into an aqueous solution at 90° C. having a concentration of 5% by mass:
(2) The binder for an electricity storage device according to (1), wherein the ethylenic unsaturated dicarboxylic acid derivative (A) is at least one selected from the group consisting of an ethylenic unsaturated dicarboxylic acid monoester, an ethylenic unsaturated dicarboxylic acid diester, and an ethylenic unsaturated dicarboxylic acid anhydride;
(3) The binder for an electricity storage device according to (1) or (2), wherein the ethylenic unsaturated dicarboxylic acid derivative (A) is at least one selected from the group consisting of a maleic acid monoalkyl ester, a maleic acid dialkyl ester, maleic anhydride, a fumaric acid monoalkyl ester, and a fumaric acid dialkyl ester;
(4) The binder for an electricity storage device according to any one of (1) to (3), wherein
   at least a part of the structural unit derived from the ethylenic unsaturated dicarboxylic acid derivative (A) constitutes a part of a structural unit represented by the following formula (I), and
   the modified vinyl alcohol polymer satisfies the following inequality (Q):

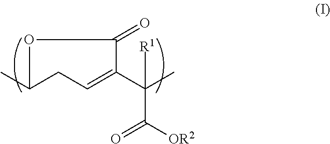

wherein, in the formula (I),
R¹ represents a hydrogen atom, or a linear or branched alkyl group having 1 to 8 carbon atoms, and
R² represents a metal atom, a hydrogen atom, or a linear or branched alkyl group having 1 to 8 carbon atoms, and

$$0. 05 ≦ \frac{Y}{X} < 0.98 \qquad ( Q )$$

in the inequality (Q),
X represents a content (mol %) of the structural unit derived from the ethylenic unsaturated dicarboxylic acid derivative (A), and
Y represents a content (mol %) of the structural unit represented by the formula (I);
(5) The binder for an electricity storage device according to any one of (1) to (4), (5) wherein
   the modified vinyl alcohol polymer is in a powder form, and
   an amount of the modified vinyl alcohol polymer capable of passing through a sieve having a mesh opening size of 1.00 mm is 95% by mass or more with respect to an entirety of the modified vinyl alcohol polymer:
(6) The binder for an electricity storage device according to any one of (1) to (5), wherein
   the modified vinyl alcohol polymer is in a powder form, and
   an amount of the modified vinyl alcohol polymer capable of passing through a sieve having a mesh opening size of 500 μm is 30% by mass or more with respect to an entirety of the modified vinyl alcohol polymer:
(7) The binder for an electricity storage device according to any one of (1) to (6), wherein the modified vinyl alcohol polymer is a modified vinyl alcohol polymer having a crosslinked structure;
(8) The binder for an electricity storage device according to any one of (1) to (7), further containing a water-soluble Li salt, wherein
   a mass ratio of the modified vinyl alcohol polymer to the water-soluble Li salt is 70:30 to 95:5;
(9) The binder for an electricity storage device according to (8), wherein a solubility of the water-soluble Li salt in water at 20° C. is 10 g/100 mL or more;
(10) The binder for an electricity storage device according to (8) or (9), wherein a molecular weight of the water-soluble Li salt is 1,000 or less;
(11) The binder for an electricity storage device according to any one of (8) to (10), wherein the water-soluble Li salt is at least one selected from the group consisting of lithium chloride, lithium acetate, lithium formate, lithium hydroxide, lithium sulfate, lithium carbonate, lithium maleate, lithium oxalate, lithium citrate, lithium bis(trifluoromethanesulfonyl)imide, and lithium bis(fluorosulfonyl)imide;
(12) A binder solution for an electricity storage device, the binder solution containing:
   the binder for an electricity storage device according to any one of (1) to (11); and a solvent;
(13) An electrode slurry for an electricity storage device, the electrode slurry containing:
   the binder solution for an electricity storage device according to (12); and an active material;
(14) The electrode slurry for an electricity storage device according to (13), wherein a content of the binder for an electricity storage device with respect to 100 parts by mass of the active material is 0.1 parts by mass or more and 20 parts by mass or less;
(15) An electrode for an electricity storage device, the electrode including:
   a hardened product of the electrode slurry for an electricity storage device according to (13) or (14); and
   a current collector;
(16) An electricity storage device including the electrode for an electricity storage device according to (15).

### Effects of the Invention

The binder for an electricity storage device, the binder solution for an electricity storage device, the electrode slurry for an electricity storage device, the electrode for an electricity storage device, and the electricity storage device of the present disclosure are superior in peel strength and superior in resistance characteristics.

### DESCRIPTION OF EMBODIMENTS

Hereinafter, embodiments for carrying out the present invention are described in detail. It is to be noted that the present invention is not to be construed as being limited to the below embodiments. It is to be noted that herein, upper limit values and lower limit values of numerical value ranges (contents of components, values and physical properties calculated from components, etc.) can be combined as appropriate. Furthermore, numerical value ranges represented using the term “to” have the meaning of including the upper limit value and the lower limit value. In other words, “A to B” means “A or more and B or less.”

### Binder for Electricity Storage Device

The binder for an electricity storage device of the present disclosure (hereinafter, may be also referred to as merely “binder”) is a binder for an electricity storage device, the binder containing a modified vinyl alcohol polymer, wherein the modified vinyl alcohol polymer has: a content of a structural unit derived from an ethylenic unsaturated dicarboxylic acid derivative (A) being 0.05 mol % or more and 10 mol % or less, a degree of saponification of 70.0 mol % or more and 99.9 mol % or less, and an amount of insoluble content being 0.1 ppm or more and less than 2.000 ppm, when the modified vinyl alcohol polymer is prepared into an aqueous solution at 90° C. having a concentration of 5% by mass. Furthermore, one preferred embodiment of the binder for an electricity storage device of the present application is the binder for an electricity storage device electrode.

The vinyl alcohol polymer (herein, may be also referred to as “polyvinyl alcohol” or “PVA”) is a polymer having a vinyl alcohol unit as a monomer unit. The PVA is obtained by saponifying a vinyl ester polymer resulting from polymerizing a vinyl ester monomer, being a raw material monomer of the PVA, and the PVA after the saponification may include a vinyl ester unit in addition to the vinyl alcohol unit.

Furthermore, the PVA may be: a PVA resulting from saponifying a copolymer obtained by copolymerizing the vinyl ester monomer, being the raw material monomer of the PVA, with another monomer, whereby other monomer unit(s) aside from the vinyl alcohol unit and the vinyl ester unit is/are contained. In the present disclosure, such a PVA is referred to as the “modified vinyl alcohol polymer (modified PVA)”; and furthermore, among raw material monomers of the modified PVA, monomer(s) other than the vinyl ester monomer may be referred to as “modifying species”. Moreover, the polymer before saponifying the (modified) PVA may be referred to as the (modified) vinyl ester polymer. It is to be noted that as referred to, the “modified vinyl ester polymer” means the vinyl ester polymer containing the other monomer unit(s) aside from the vinyl ester unit.

The modified PVA of the present disclosure has favorable affinity to active materials to be used in an electricity storage device, such as carbon materials, metals, metal oxides, and the like. Thus, the modified PVA when used as a binder allows for obtaining an electrode having high peel strength and low resistance.

The degree of saponification of the modified PVA of the present disclosure is 70.0 mol % or more and 99.9 mol % or less. The degree of saponification is preferably 82.0 mol % or more and 99.0 mol % or less, and may be more preferably 85.0 mol % or more and 95.0 mol % or less. In a case in which the degree of saponification is less than 70.0 mol %, practical physical properties of the electrode to be obtained, such as the peel strength and resistance characteristics, may be insufficient, and furthermore, it may be difficult for the amount of insoluble content to be less than 2.000 ppm, when the modified PVA is prepared into an aqueous solution at 90° C. having a concentration of 5% by mass. The degree of saponification of the modified PVA can be measured in accordance with a procedure disclosed in JIS K 6726 (1994).

A viscosity-average degree of polymerization (hereinafter, may be also referred to as merely “degree of polymerization”) of the modified PVA of the present application is not particularly limited, and is preferably 100 to 5.000, more preferably 150 to 4.500, and may be still more preferably 200 to 4.000. The lower limit of the degree of polymerization may be 300 or 500. The degree of polymerization of the modified PVA can be measured in accordance with a procedure disclosed in JIS K 6726 (1994).

When the modified PVA of the present disclosure is prepared into an aqueous solution at 90° C. having a concentration of 5% by mass, the amount of insoluble content is 0.1 ppm or more and less than 2.000 ppm. In other words, the amount of insoluble content (modified PVA) in an aqueous solution at 90° C. having a concentration of 5% by mass, being the aqueous solution of the modified PVA of the present disclosure, is 0.1 ppm or more and less than 2.000 ppm. The amount of insoluble content when the aqueous solution at 90° C. having a concentration of 5% by mass is prepared is preferably 0.1 ppm or more and less than 1.000 ppm, and may be more preferably 0.1 ppm or more and less than 500 ppm. In a case in which the amount of insoluble content is 2.000 ppm or more when the specific aqueous solution is prepared, peel strength of an electrode obtained when the modified PVA is used as a binder may decrease, and/or resistance thereof may increase. It is to be noted that herein, ppm means ppm on mass basis.

The insoluble content when the aqueous solution at 90° C. having a concentration of 5% by mass is prepared is decided by the following method. A 500 mL flask equipped with an agitator and a reflux condenser is placed in a water bath set to 20° C. Distilled water in an amount of 285 g is charged into the flask, and stirring is started at 300 rpm. After weighing out 15 g of a modified PVA, the modified PVA is gradually charged into the flask. When an entirety of the PVA (15 g) has been charged, the modified PVA is dissolved by elevating a temperature of the water bath to 90° C. over a time period of about 30 min to give a solution of the modified PVA. After the temperature of the water bath reaches 90° C. the dissolution is continued while further stirring for 60 min at 300 rpm. Thereafter, the modified PVA solution is used to filter out undissolved, residual particles of the modified PVA (hereinafter, may be referred to as “undissolved particles”) with a metal filter having a mesh opening size of 63 μm. Next, the filter is washed well with hot water at 90° C. to remove the modified PVA solution attached to the filter to retain only the undissolved particles on the filter, and then the filter is dried for 1 hour with a heating dryer at 120° C. A mass of the filter after the drying and a mass of the filter before being used for the filtering are compared to calculate a mass of the undissolved particles. The ppm on mass basis of the undissolved particles with respect to a total amount of the modified PVA used for preparing the aqueous solution of the modified PVA is defined as the amount of insoluble content when the aqueous solution at 90° C. having a concentration of 5% by mass is prepared. It is to be noted that herein, the amount of insoluble content when the aqueous solution at 90° C. having a concentration of 5% by mass is prepared may be referred to as an “amount of water-insoluble content.”

The modified PVA of the present disclosure has a structural unit derived from an ethylenic unsaturated dicarboxylic acid derivative (A).

A content (X) of the structural unit derived from the ethylenic unsaturated dicarboxylic acid derivative (A) in the modified PVA is 0.05 mol % or more and 10 mol % or less. The content (X) is preferably 0.1 mol % or more and 5.0 mol % or less, and may be more preferably 0.2 mol % or more and 2.0 mol % or less. In a case in which the content (X) of the structural unit derived from the ethylenic unsaturated dicarboxylic acid derivative (A) is less than 0.05 mol %, the amount of carboxylic acid incorporated into the modified PVA being low may result in a decrease of the peel strength of the electrode obtained when using the modified PVA as a binder. Furthermore, in a case in which the content (X) is more than 10 mol %, problems may occur in handling, such as particles of a powder of the modified PVA adhering together due to moisture in the air and forming a block; and/or generation of insoluble content in water due to crosslinking during production may increase, whereby controlling the amount of insoluble content to be less than 2.000 ppm may be difficult. Furthermore, herein, the content (X) of the structural unit derived from the ethylenic unsaturated dicarboxylic acid derivative (A) in the modified PVA may be referred to “degree of modification (X).” It is to be noted that the degree of modification (X) means a percentage of the number of moles of the structural unit derived from the ethylenic unsaturated dicarboxylic acid derivative (A) with respect to a total number of moles of monomer units constituting the main chain of the modified PVA. The degree of modification (X) can be calculated by ¹H-NMR analysis on the modified vinyl ester polymer (C) before saponifying the modified PVA.

As long as the effects of the present disclosure are not impaired, the ethylenic unsaturated dicarboxylic acid derivative (A) to be used in the present disclosure is not particularly limited. As the ethylenic unsaturated dicarboxylic acid derivative (A), an ethylenic unsaturated dicarboxylic acid monoester, an ethylenic unsaturated dicarboxylic acid diester, or an ethylenic unsaturated dicarboxylic acid anhydride is preferred as a monomer. Specific examples of the ethylenic unsaturated dicarboxylic acid derivative (A) include: monoalkyl unsaturated dicarboxylic acid esters such as monomethyl maleate, monoethyl maleate, monomethyl fumarate, monoethyl fumarate, monomethyl citraconate, monoethyl citraconate, monomethyl mesaconate, monoethyl mesaconate, monomethyl itaconate, and monoethyl itaconate; dialkyl unsaturated dicarboxylic acid esters such as dimethyl maleate, diethyl maleate, dimethyl fumarate, diethyl fumarate, dimethyl citraconate, diethyl citraconate, dimethyl mesaconate, diethyl mesaconate, dimethyl itaconate, and diethyl itaconate; and unsaturated dicarboxylic acid anhydrides such as maleic anhydride, and citraconic anhydride. In light of industrial availability and reactivity with vinyl ester monomers, a maleic acid monoalkyl ester, a maleic acid dialkyl ester, maleic anhydride, a fumaric acid monoalkyl ester, or a fumaric acid dialkyl ester is preferred, and monomethyl maleate or maleic anhydride may be more preferred. The modified PVA of the present disclosure may have a structural unit derived from at least one type of the ethylenic unsaturated dicarboxylic acid derivative (A), or may have a structural unit derived from two or more types of the ethylenic unsaturated dicarboxylic acid derivative (A).

In the modified PVA of the present disclosure, in light of enabling further decreasing the amount of water-insoluble content, it is preferred that at least a part of the structural unit derived from the ethylenic unsaturated dicarboxylic acid derivative (A) constitutes a part of a structural unit represented by the following formula (I), and the modified PVA satisfies the following inequality (Q).

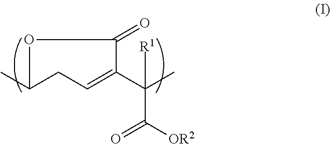

In the formula (I), R¹ represents a hydrogen atom, or a linear or branched alkyl group having 1 to 8 carbon atoms; and R² represents a metal atom, a hydrogen atom, or a linear or branched alkyl group having 1 to 8 carbon atoms.

$$0. 05 ≦ \frac{Y}{X} < 0.98 \qquad ( Q )$$

In the inequality (Q), X represents a content (X) (mol %) of the structural unit derived from the ethylenic unsaturated dicarboxylic acid derivative (A); and Y represents a content (Y) (mol %) of the structural unit represented by the formula (I). In other words, X is the above-described degree of modification (X). Furthermore, the content (Y) of the structural unit represented by the formula (I) may be referred to as “degree of modification (Y).”

When Y/X satisfies the range represented by the inequality (Q), the modified PVA having a reduced amount of water-insoluble content can be more easily produced industrially. The lower limit of Y/X may be more preferably 0.06, 0.07, or 0.10. On the other hand, the upper limit of Y/X is more preferably 0.80, still more preferably 0.60, and may be particularly preferably 0.40. It is to be noted that the content (Y) of the structural unit represented by the formula (I) is the percentage of the number of moles of the structural unit represented by the formula (I) with respect to the total number of moles of the monomer units constituting the main chain of the modified PVA.

Examples of the linear or branched alkyl group having 1 to 8 carbon atoms which may be represented by each of R¹ and R² include a methyl group, an ethyl group, an n-propyl group, an isopropyl group, an n-butyl group, an isobutyl group, a sec-butyl group, a 2-methylpropyl group, a tert-butyl group, an n-pentyl group, an isopentyl group, a sec-pentyl group, a neopentyl group, a tert-pentyl group, a 1-ethylpropyl group, a 1,1-dimethylpropyl group, a 1,2-dimethylpropyl group, an n-hexyl group, a 1-methylpentyl group, a 2-methylpentyl group, a 3-methylpentyl group, a 4-methylpentyl (isohexyl) group, a 1-ethylbutyl group, a 2-ethylbutyl group, a 1,1-dimethylbutyl group, a 1,2-dimethylbutyl group, a 1,3-dimethylbutyl group, a 1,4-dimethylbutyl group, a 2,2-dimethylbutyl group, a 2,3-dimethylbutyl group, a 3,3-dimethylbutyl group, a 1-ethyl-2-methyl-propyl group, a 1,1,2-trimethylpropyl group, an n-heptyl group, a 2-methylhexyl group, an n-octyl group, an isooctyl group, a tert-octyl group, a 2-ethylhexyl group, a 3-methylheptyl group, and the like. The number of carbon atoms in the alkyl group is preferably 1 to 6 and more preferably 1 to 4, and may be still more preferably 1 to 3.

Examples of the metal atom which may be represented by R² include: alkali metals such as lithium, sodium, potassium, rubidium, and cesium; and alkali earth metals such as calcium, barium, strontium, and radium. Of these, the alkali metals are preferred, and lithium or sodium may be more preferred.

In the case in which the modified PVA is produced by using the ethylenic unsaturated dicarboxylic acid derivative (A), a part of the structural unit derived from the ethylenic unsaturated dicarboxylic acid derivative (A) incorporated into the modified PVA may, after saponification, form the six-membered lactone ring structure represented in the formula (I). The six-membered lactone ring structure represented in the formula (I) may open its ring under heat, and form a crosslinked product by subsequently undergoing an intermolecular esterification reaction, and at this time, the amount of water-insoluble content in the modified PVA may increase. More specifically, when the content (Y) of the structural unit represented by the formula (I) is high with respect to the content (X) of the incorporated structural unit derived from the ethylenic unsaturated dicarboxylic acid derivative (A), this means that the crosslinking reaction has been inhibited. It is considered that the six-membered lactone ring structure in the formula (I) can be detected at 6.8 to 7.2 ppm in a ¹H-NMR spectrum, measured using a deuterated dimethyl sulfoxide solvent. In light of more easily controlling the amount of water-insoluble content in the modified PVA of the present disclosure to be less than 2.000 ppm, the content (Y) of the structural unit represented by the formula (I) preferably satisfies the inequality (Q) with respect to the content (X) of the structural unit derived from the ethylenic unsaturated dicarboxylic acid derivative (A), determined from the modified vinyl ester polymer (C) before saponification. It is to be noted that a case in which Y/X is 0.50 in the inequality (Q) means that half of total incorporated structural units derived from the ethylenic unsaturated dicarboxylic acid derivative (A) have formed the structural unit represented by the formula (I).

A form of the modified PVA of the present disclosure is not particularly limited, but the modified PVA powder, being in a powder form, is preferred. A particle diameter of the particles constituting the powder is not particularly limited, and it is preferred that 95% by mass or more of an entirety of the modified PVA powder is capable of passing through a sieve having a mesh opening size of 1.00 mm, and may be more preferred that 95% by mass or more of the entirety of the modified PVA powder is capable of passing through a sieve having a mesh opening size of 710 μm. Herein. “95% by mass or more of the entirety of the modified PVA powder” means, as a particle size distribution, for example, a cumulative distribution in which 95% by mass or more of particles are capable of passing through a sieve having a mesh opening size of 1.00 mm. When the particles capable of passing through a sieve having a mesh opening size of 1.00 mm account for 95% by mass or more, drying unevenness can be further inhibited due to the particles being small, and the amount of water-insoluble content can be more easily controlled. Furthermore, the particle diameter of the particles constituting the modified PVA powder of the present disclosure is such that, with respect to the entirety of the modified PVA powder, the amount capable of passing through a sieving having a mesh opening size of 500 μm is preferably 30% by mass or more, more preferably 35% by mass or more, still more preferably 45% by mass or more, and may be particularly preferably 56% by mass or more. Moreover, the particle diameter of the particles constituting the modified PVA powder is preferably such that 99% by mass or more of the modified PVA powder are capable of passing through a sieve having a mesh opening size of 1.00 mm, and may be more preferably such that 99% by mass or more of the modified PVA powder is capable of passing through a sieve having a mesh opening size of 1.00 mm and 56% by mass or more is capable of passing through a sieve having a mesh opening size of 500 μm. The sieve mesh opening sizes conform to the nominal mesh opening size W of JIS Z 8801-1 (2006).

In the binder for an electricity storage device of the present disclosure, the modified PVA may preferably have a crosslinked structure. The crosslinked structure may be a structure in which the structural unit derived from the ethylenic unsaturated dicarboxylic acid derivative (A) in the modified PVA forms crosslinks between molecules. Furthermore, the crosslinked structure of the modified PVA may be formed in a binder solution for an electricity storage device, an electrode slurry for an electricity storage device, an electrode for an electricity storage device, and/or an electricity storage device, each described later.

### Method for Producing Modified PVA

Hereinafter, a method for producing the modified PVA of the present disclosure is described in detail. It is to be noted that the method for producing the modified PVA of the present disclosure is not limited to the embodiments described below:

The modified PVA of the present disclosure is produced by, for example, a method that includes: a step of copolymerizing the ethylenic unsaturated dicarboxylic acid derivative (A) with a vinyl ester monomer (B) to obtain the modified vinyl ester polymer (C); a saponification step of saponifying the modified vinyl ester polymer (C) thus obtained in an alcohol solution with an alkali catalyst or an acid catalyst; a washing step; and a drying step.

Examples of the vinyl ester monomer (B) include vinyl formate, vinyl acetate, vinyl propionate, vinyl valarate, vinyl caprate, vinyl laurate, vinyl stearate, vinyl benzoate, vinyl pivalate, vinyl versatate, and the like, and vinyl acetate is preferred.

The procedure of copolymerizing the ethylenic unsaturated dicarboxylic acid derivative (A) with the vinyl ester monomer (B) may be exemplified by well-known procedures such as bulk polymerization, solution polymerization, suspension polymerization, emulsion polymerization, and the like. Of these procedures, bulk polymerization, in which no solvent is used, or solution polymerization, in which a solvent such as an alcohol is used, is typically employed. In light of enhancing the effects of the present disclosure, solution polymerization, in which polymerization is performed with a lower alcohol such as methanol, is preferred. In the case of performing the polymerization reaction by means of bulk polymerization or solution polymerization, either a batch type or a continuous type may be used for the reaction system.

The initiator used for the polymerization reaction is not particularly limited within a range not impairing the effects of the present disclosure, and examples thereof include well-known initiators, e.g., azo initiators such as 2,2′-azobis(isobutyronitrile), 2,2′-azobis(2,4-dimethylvaleronitrile), and 2,2′-azobis(4-methoxy-2,4-dimethylvaleronitrile); organic peroxide initiators such as benzoyl peroxide, and n-propyl peroxycarbonate; and the like. The polymerization temperature when performing the polymerization reaction is not particularly limited, and may be in a range of 5 to 200° C., or in a range of 30 to 150° C.

For copolymerization of the ethylenic unsaturated dicarboxylic acid derivative (A) with the vinyl ester monomer (B), a copolymerizable other monomer (D) aside from the ethylenic unsaturated dicarboxylic acid derivative (A) and the vinyl ester monomer (B) may further be copolymerized as needed, within a range not impairing the effects of the present disclosure. Examples of the monomer (D) include:
α-olefins such as ethylene, propylene, 1-butene, isobutene, and 1-hexene;
acrylamide monomers such as acrylamide, N-methyl acrylamide, and N-ethyl acrylamide;
methacrylamide monomers such as methacrylamide, N-methyl methacrylamide, and N-ethyl meth acrylamide;
vinyl ether monomers such as methyl vinyl ether, ethyl vinyl ether, n-propyl vinyl ether, isopropyl vinyl ether, and n-butyl vinyl ether;
hydroxyl-containing vinyl ether monomers such as ethylene glycol vinyl ether, 1,3-propanediol vinyl ether, and 1,4-butanediol vinyl ether;
allyl ether monomers such as propyl allyl ether, butyl allyl ether, and hexyl allyl ether;
monomers having an oxyalkylene group;
hydroxyl-containing α-olefins such as isopropenyl acetate, 3-buten-1-ol, 4-penten-1-ol, 5-hexen-1-ol, 7-octen-1-ol, 9-decen-1-ol, and 3-methyl-3-buten-1-ol;
monomers having a silyl group, such as vinyltrimethoxysilane, vinylmethyldimethoxysilane, vinyldimethylmethoxysilane, vinyltriethoxysilane, vinylmethyldiethoxysilane, vinyldimethylethoxysilane, 3-(meth)acrylamide-propyltrimethoxysilane, and 3-(meth)acrylamide-propyltriethoxysilane;
N-vinylamide monomers such as N-vinylformamide, N-vinylacetamide, N-vinyl-2-pyrrolidone, and N-vinyl-2-caprolactam; and the like.

Although a usage amount of these monomers (D) may vary in accordance with a usage purpose thereof and the like, typically, the usage amount in terms of a proportion with respect to total monomers used in the copolymer is 10 mol % or less, preferably 5.0 mol % or less, more preferably 3.0 mol % or less, and further preferably 2.0 mol % or less.

The modified PVA is obtained by subjecting the modified vinyl ester polymer (C) obtained in the copolymerization step to the step of saponification in an alcohol solvent, followed by the washing step and the drying step. The saponification and drying conditions for obtaining the modified PVA of the present disclosure are not particularly limited: however, in light of reducing the amount of water-insoluble content present in the modified PVA, it is preferred that a moisture content of the raw saponification solution, a temperature of the PVA resin during the drying, and a drying time period fall within a certain range.

The raw saponification solution may be prepared by adding a small amount of water to the solution containing the solvent and the modified vinyl ester polymer (C) obtained in the copolymerization step. The amount of addition of water is preferably adjusted such that the moisture content of the raw saponification solution (may be also referred to as “moisture content in the system”) to be obtained is more than 1.0% by mass and less than 5.0% by mass. The moisture content may be more preferably 1.5 to 4.0% by mass. When the moisture content falls within the above range, an action of the alkali catalyst as a catalyst in the crosslinking reaction can be further inhibited, the amount of water-insoluble content can be more easily controlled during the drying, and further, a rate of the saponification reaction can be made more favorable.

Examples of solvents that can be used in the saponification reaction include methanol, ethanol, isopropyl alcohol, and the like. These may be used alone of one type, or two or more types can be used together. Furthermore, within a range not interfering with the saponification reaction step, the solvent may be a mixed solvent involving an ester such as methyl acetate also being present. Of these solvents, methanol or a mixed solvent of methanol and methyl acetate can be preferably used.

Typically, an alkali catalyst is used as the catalyst of the saponification reaction of the modified vinyl ester polymer (C). Examples of the alkali catalyst include alkali metal hydroxides such as lithium hydroxide, potassium hydroxide, and sodium hydroxide; and alkali metal alkoxides such as sodium methoxide. Sodium hydroxide is preferred. The usage amount of the catalyst in terms of a molar ratio of the modified vinyl ester polymer (C) with respect to the vinyl ester monomer unit is preferably 0.005 to 0.50, more preferably 0.008 to 0.40, and may be still more preferably 0.01 to 0.30. The catalyst may be added at once in an initial stage of the saponification reaction, or a part thereof may be added in the initial stage of the saponification reaction and the remainder may be further added during the saponification reaction.

The saponification reaction temperature is preferably 5 to 80° C. and may be more preferably 20 to 70° C. The saponification reaction time period is preferably 5 min to 10 hrs, and may be more preferably 10 min to 5 hrs. The saponification reaction system may be a batch procedure or a continuous procedure. In a saponification reaction using an alkali catalyst, any remaining catalyst may be neutralized by adding an acid such as acetic acid or lactic acid, as needed, in order to stop the saponification reaction. However, in light of further reducing to control the amount of water-insoluble content to less than 2.000 ppm, it is preferred that such neutralization by addition of an acid is not performed, because any remaining acid after the neutralization tends to facilitate a crosslinking reaction between molecules of the modified PVA during the drying.

The saponification reaction is not particularly limited as long as it is carried out by a well-known method. Examples of such methods include:
(1) a method in which a catalyst is mixed with a solution of the modified vinyl ester polymer (C) prepared to have a concentration of more than 20% by mass, and the semi-solid (gelatinous material) or solid obtained is ground with a grinder to obtain the modified PVA powder;
(2) a method in which the entire reaction solution taking on a gelatinous, non-fluid form is inhibited by controlling a concentration of the modified vinyl ester polymer (C), dissolved in a solvent containing an alcohol (preferably methanol), to be less than 10% by mass, and then precipitating the modified PVA in the solvent to obtain the modified PVA as fine particles dispersed in methanol; and
(3) a method in which the modified vinyl ester polymer (C) is emulsified by adding a saturated hydrocarbon solvent, or saponified in a suspended phase to obtain the modified PVA powder; and the like.

In method (1), the grinder is not particularly limited, and well-known grinders or comminutors may be used. In light of production, method (1) or (2) is preferred due to not requiring a saturated hydrocarbon solvent. Method (2) is also preferred in terms of being industrially advantageous due to enabling the amount of water-insoluble content to be a trace amount even in a case in which the subsequent washing step and drying step are made weaker than is conventional.

In light of enabling reducing the amount of water-insoluble content in the modified PVA to be obtained, a step of washing the modified PVA as needed is preferably added after the saponification step. As the washing liquid, a solution containing a lower alcohol such as methanol as a principal component, and further containing water and/or an ester such as methyl acetate may be used. The washing liquid is preferably a solution containing methanol as a principal component and containing methyl acetate. For economy and ease of procedures, it is preferred that methanol, which is suitably used in the copolymerization step of the modified vinyl ester polymer (C), and methyl acetate generated in the saponification step are used as a washing liquid due to enabling recycling the washing liquid in the steps, and preparation of another solvent as the washing liquid not being necessary. In order to reduce the amount of water-insoluble content in the modified PVA to be obtained, a content of methyl acetate is preferably 50% by volume or more, more preferably 60% by volume or more, and may be still more preferably 70% by volume or more.

The modified PVA being in the powder form can be obtained by drying the polymer, after the saponification step or after the washing step. Specifically, the polymer is dried preferably by hot-air drying using a cylindrical dryer, and a temperature of the modified PVA at the time of drying is preferably more than 80° C. and less than 120° C. and may be more preferably 90° C. or more and less than 110° C. The drying time period is preferably 2 to 10 hrs, and may be more preferably 3 to 8 hrs. When the conditions at the time of drying fall within the above ranges, it becomes easier to further reduce the amount of water-insoluble content present in the modified PVA to be obtained to less than 2.000 ppm.

As one embodiment of the present invention, the binder for an electricity storage device of the present disclosure may contain two or more types of PVAs. For example, the binder for an electricity storage device may contain the modified PVA and another PVA (E), and in this case, a content of the PVA (E) with respect to a total amount of the modified PVA and the PVA (E) may be 0% by mass or more and 70% by mass or less. The content of the PVA (E) is preferably 60% by mass or less, more preferably 50% by mass or less, still more preferably 40% by mass or less, yet more preferably 20% by mass or less, and may be particularly preferably 10% by mass or less. Furthermore, the content of the PVA (E) may be 0) % by mass. The PVA in the binder for an electricity storage device may all be the single modified PVA. A viscosity-average degree of polymerization of the PVA (E) is not particularly limited and may be, for example, 100 or more and 5.000 or less, and is preferably 200 or more and 3.000 or less, and may be more preferably 400 or more and 2.000 or less. Furthermore, the viscosity-average degree of polymerization of the PVA (E) is preferably less than or equal to the viscosity-average degree of polymerization of the modified PVA. The viscosity-average degree of polymerization of the PVA (E) can be measured in accordance with a procedure disclosed in JIS K 6726 (1994). Furthermore, a degree of saponification of the PVA (E) may be 80.0 mol % or more and 99.9 mol % or less. The degree of saponification of the PVA (E) can be measured in accordance with a procedure disclosed in JIS K 6726 (1994). Furthermore, the PVA (E) may be modified. The PVA (E) may be a modified PVA which can have the content (X) of the structural unit derived from the ethylenic unsaturated dicarboxylic acid derivative (A) being 0.05 mol % or more and 10 mol % or less, the degree of saponification being 70.0 mol % or more and 99.9 mol % or less, and an amount of insoluble content being 0.1 ppm or more and less than 2.000 ppm, when the PVA (E) is prepared into an aqueous solution at 90° C. having a concentration of 5% by mass; or may be a PVA which does not satisfy all of these features. Furthermore, the amount of water-insoluble content in total PVAs, including the modified PVA (the amount of water-insoluble content with respect to the total PVAs), contained in the binder for an electricity storage device is preferably 0.1 ppm or more and less than 2.000 ppm, more preferably 0.1 ppm or more and less than 1.000 ppm, and may be still more preferably 0.1 ppm or more and less than 500 ppm.

In light of affinity to carbon materials such as graphite increasing and adhesiveness and coating characteristics being favorable, the modified PVA of the present disclosure can preferably be dissolved in N-methyl-2-pyrrolidone such that a solid content concentration is 7.5% by mass or more, under heating with stirring conditions involving 90° C. and 2 hrs. It may be preferred that dissolution is possible such that the solid content concentration is more preferably 8.0% by mass or more, and still more preferably 8.5% by mass or more.

When the binder for an electricity storage device of the present disclosure further contains a water-soluble Li salt (water-soluble lithium salt) in addition to the modified PVA, further improving ion conductivity of an electrode is facilitated. It is to be noted that herein. “Li salt” means a compound consisting of a lithium ion and an anion, and encompasses LiOH and the like. A mass ratio of the modified PVA to the water-soluble Li salt is preferably 70:30 to 95:5, more preferably 78:12 to 94:6, and may be still more preferably 80:20 to 92:8. When the mass ratio falls within the above range, the ion conductivity can be further improved, whereby the resistance can be further reduced, the adhesiveness can be further enhanced, and there is a tendency for breakage during electrode cutting being less likely to occur. Furthermore, in the case in which the binder for an electricity storage device contains two or more types of PVAs, a mass ratio of the water-soluble Li salt to the total amount of PVAs, including the modified PVA, may be 70:30 to 98:2, and is preferably 80:20 to 95:5, and may be more preferably 85:15 to 94:6.

A solubility of the water-soluble Li salt in water at 20° C. is preferably 10 g/100 mL or more. When the solubility in water falls within the above range, the water-soluble Li salt tends to be present more uniformly in the modified PVA in the binder for an electricity storage device, and the effect of reducing the resistance tends to be more pronounced.

Furthermore, a molecular weight of the water-soluble Li salt is preferably 1.000 or less, more preferably 700 or less, and may be still more preferably 500 or less. When the molecular weight is more than or equal to the predetermined upper limit, the water-soluble Li salt tends to be present more uniformly in the modified PVA, and the effect of reducing the resistance tends to be more pronounced. Moreover, when the modified PVA is made into a slurry, excessively increased viscosity is less likely to occur, whereby an electrode having higher uniformity can be more easily obtained.

Examples of the water-soluble Li salt include lithium chloride, lithium acetate, lithium formate, lithium hydroxide, lithium sulfate, lithium carbonate, lithium maleate, lithium oxalate, lithium citrate, lithium bis(fluorosulfonyl)imide, lithium bis(trifluoromethanesulfonyl)imide, and the like. As the water-soluble Li salt, lithium chloride, lithium acetate, lithium formate, lithium hydroxide, lithium sulfate, lithium maleate, lithium oxalate, lithium citrate, lithium bis(fluorosulfonyl)imide, and lithium bis(trifluoromethanesulfonyl)imide are preferred. Furthermore, as the water-soluble Li salt, lithium acetate, lithium formate, lithium hydroxide, lithium sulfate, lithium carbonate, lithium maleate, lithium oxalate, lithium citrate, and lithium bis(fluorosulfonyl)imide may be preferred. These water-soluble Li salts may be used alone of one type, or in a combination of two or more types thereof.

A procedure of adding the water-soluble Li salt may be exemplified by: charging as a powder; charging in a state of mixing with other substance(s), such as an active material; charging as a solution of the water-soluble Li salt; charging in a state of the water-soluble Li salt being present together with a binder solution; and the like. These adding procedures are not particularly limited, and in light of dispersing the water-soluble Li salt in the polyvinyl alcohol resin, charging in the state of the water-soluble Li salt being present together with a binder solution is preferred.

The binder of the present disclosure may further contain a material that adjusts the viscosity of the binder in an aqueous solution state or an N-methyl-2-pyrrolidone (NMP) solution state. Examples of the material that adjusts the viscosity include: polyvalent basic acids such as citric acid, tartaric acid, and aspartic acid, and salts and condensates thereof; and inorganic substances such as fumed silica and alumina. The amount of addition of these materials is not particularly limited, and is typically, with respect to 100 parts by mass of the total PVAs including the modified PVA of the present disclosure, preferably 0.01 parts by mass or more and 10 parts by mass or less, more preferably 0.02 parts by mass or more and 8 parts by mass or less, and may be still more preferably 0.05 parts by mass or more and 5 parts by mass or less. The viscosity of the binder of the present disclosure in a solution state can be further increased and more easily adjusted within the predetermined range by incorporating a larger amount of the material that adjusts the viscosity. With regard to the inorganic substance, the particle size thereof to be incorporated being smaller results in the viscosity of the binder in an aqueous solution state or NMP solution state being more easily increased.

The binder for an electricity storage device of the present disclosure or the binder solution for an electricity storage device, described later, may further contain compounding agent(s) within a range not impairing the effects of the present disclosure. Examples of the compounding agent include light stabilizers. UV absorbers, cryostabilizers, thickening agents, leveling agents, rheology stabilizers, thixotropic agents, antifoaming agents, plasticizers, lubricants, preservatives, corrosion inhibitors, antistatic agents, charge inhibitors, anti-yellowing agents, pH modifiers, film-forming aids, curing catalysts, crosslinking reaction catalysts, crosslinking agents (e.g., glyoxal, urea resins, melamine resins, polyvalent metal salts, polyisocyanates, and polyamide epichlorohydrin), dispersants, and the like. These compounding agents can each be selected in accordance with their intended purposes, and may be incorporated in a combination. The content of the compounding agents with respect to the total amount of the binder for an electricity storage device or the binder solution for an electricity storage device is, for example, 10% by mass or less, preferably 5% by mass or less, and may be more preferably 1% by mass or less.

The binder for an electricity storage device of the present disclosure can be obtained by dissolving the modified PVA in a solvent (water. NMP, or the like) along with component(s) other than the modified PVA that are incorporated as needed to prepare a solution, and subsequently removing the solvent. Furthermore, this solution may be directly used as the binder solution for an electricity storage device, described later, in the subsequent preparation of the electrode slurry for an electricity storage device. In a hardened product of the electrode slurry for an electricity storage device, the binder of the present disclosure is contained in a state of being mixed with components such as the active material.

### Binder Solution for Electricity Storage Device

The binder solution for an electricity storage device (hereinafter, may be also referred to as merely “binder solution”) can be obtained by dissolving the binder for an electricity storage device of the present disclosure in at least one solvent. The solvent is not particularly limited, and is preferably water or NMP. The case in which the solvent is water is suitable in light of environmental load reduction and equipment simplicity. On the other hand, the case in which the solvent is NMP is suitable since, especially when the binder solution is applied as a positive electrode slurry, deterioration of an active material in the slurry is less likely to occur.

Within a range not impairing the effects of the present disclosure, the binder solution may contain, in addition to the above-described binder of the present disclosure, an additive (hereinafter referred to as “additive (F)”) that can be dissolved in the solvent. Examples of the additive (F) include polyethylene glycol, polyethylene glycol dimethyl ether, polyethylene glycol diglycidyl ether, polyethyleneimine, and the like. The content of the additive (F) with respect to a total amount of the binder solution is, for example, 10% by mass or less, preferably 5% by mass or less, and may be more preferably 1% by mass or less. Furthermore, it may be preferred that the binder solution does not contain the additive (F).

The binder solution can be obtained by mixing the binder of the present disclosure, the solvent (water. NMP, or the like), and the above-described components other than the binder, which are optionally contained as needed, by a well-known method such as stirring. The mixing temperature and mixing time period can be adjusted as appropriate in accordance with the type of the solvent. It is to be noted that in the binder solution, the mass of the binder dissolved in the solvent is, with respect to a total mass (100% by mass) of the binder used in the binder solution, preferably 80% by mass or more, more preferably 90% by mass or more, still more preferably 95% by mass or more, yet more preferably 99% by mass or more, and may be particularly preferably 100% by mass.

The content of the binder in the binder solution of the present disclosure with respect to the total amount of the binder solution is preferably 1% by mass or more and 30% by mass or less, more preferably 3% by mass or more and 20% by mass or less, and may be still more preferably 5% by mass or more and 15% by mass or less. When the content of the binder is 1% by mass or more, the adhesiveness of the active material to a current collector in the formation of an electrode is likely to be further improved. When the content of the binder is 30% by mass or less, rapid aggregation of the active material in the formation of an electrode can be further inhibited.

### Electrode Slurry for Electricity Storage Device

The electrode slurry for an electricity storage device of the present disclosure contains the above-described binder solution of the present disclosure, and an active material.

The electrode slurry for an electricity storage device of the present disclosure may be used for either a positive electrode or a negative electrode. Furthermore, the electrode slurry for an electricity storage device may be used for both a positive electrode and a negative electrode. Thus, the active material may be either a positive electrode active material or a negative electrode active material. In a case in which the binder solution of the present disclosure contains water (in a case in which the solvent is water), the electrode slurry for an electricity storage device preferably contains a negative electrode active material and is used as a negative electrode slurry. In a case in which the binder solution of the present disclosure contains NMP (in a case in which the solvent is NMP), the electrode slurry for an electricity storage device preferably contains a positive electrode active material and is used as a positive electrode slurry.

As the negative electrode active material, for example, a material conventionally used as a negative electrode active material of an electricity storage device can be used. Examples thereof include: carbonaceous materials such amorphous carbon, artificial graphite, natural graphite (graphite), mesocarbon microbeads (MCMB), pitch-based carbon fibers, carbon black, activated carbon, carbon fibers, hard carbon, soft carbon, mesoporous carbon, and conductive polymers such as polyacene; composite metal oxides represented by SiOₓ, SnOₓ, and LiTiOₓ, and other metal oxides; lithium-based metals such as lithium metal and lithium alloys; metal compounds such as TiS₂ and LiTiS₂; composite materials formed of a metal oxide and a carbonaceous material; and the like. Of these, in light of economic efficiency and battery capacity, graphite is preferred, and spherical natural graphite may be more preferred. These negative electrode active materials may be used alone of one type, or in a combination of two or more types thereof.

As the positive electrode active material, for example, a material conventionally used as a positive electrode active material of an electricity storage device can be used. Examples thereof include: transition metal oxides such as TiS₂, TiS₃, amorphous MoS₃, Cu₂V₂O₃, amorphous V₂O—P₂O₅, MoO₃, V₂O₅, and V₆O₁₃; lithium-containing composite metal oxides such as LiCoO₂, LiNiO₂, LiMnO₂, and LiMn₂O₄; and the like. These positive electrode active materials may be used alone of one type, or in a combination of two or more types thereof.

The electrode slurry for an electricity storage device may also contain a conductive aid (conductivity-imparting agent). The conductive aid is used for increasing the output of an electricity storage device, and can be selected as appropriate in accordance with the case of the electrode slurry for an electricity storage device being for a positive electrode or a negative electrode. Examples of the conductive aid include graphite, acetylene black, carbon black, Ketjen black, vapor-grown carbon fibers, and the like. Of these, in light of a likelihood to further increase the output of the electricity storage device to be obtained, acetylene black is preferred.

When electrode slurry for an electricity storage device contains the conductive aid, a content of the conductive aid with respect to 100 parts by mass of the active material is preferably 0.1 parts by mass or more and 15 parts by mass or less, more preferably 1 part by mass or more and 10 parts by mass or less, and may be still more preferably 3 parts by mass or more and 10 parts by mass or less. When the content of the conductive aid falls within the above range, a reduction in the capacity of the electricity storage device to which the slurry is to be applied can be inhibited, and a more superior conductivity-assisting effect can be obtained.

A content of the binder in the electrode slurry for an electricity storage device with respect to 100 parts by mass of the active material is preferably 0.1 parts by mass or more and 20 parts by mass or less. When the content of the binder is 0.1 parts by mass or more, the adhesiveness of the active material to a current collector is improved, which is further advantageous in light of maintaining the durability of a battery to which the electrode slurry for an electricity storage device is to be applied. Furthermore, when the content of the binder is 20 parts by mass or less, the discharge capacity is more likely to be improved. In light of such points, the range of the content is more preferably 0.2 parts by mass or more and 18 parts by mass or less, still more preferably 0.5 parts by mass or more and 16 parts by mass or less, and may be yet more preferably 1 part by mass or more and 12 parts by mass or less. The upper limit of the content may be 10 parts by mass, 8 parts by mass, 6 parts by mass, 4 parts by mass, or 2 parts by mass.

As needed, the electrode slurry for an electricity storage device may also contain additives such as a flame retardant aid, a thickening agent, an antifoaming agent, a leveling agent, and a tackifier, in addition to the binder, the active material, the conductive aid, and the solvent. Examples of the thickening agent include polysaccharides such as carboxymethyl cellulose (CMC), salts thereof, and the like. When the slurry contains these additives, the content of the additive(s) with respect to the total amount of the slurry is preferably 0.1% by mass or more and 10% by mass or less.

The electrode slurry for an electricity storage device can be obtained by mixing the binder, the active material and as needed, the conductive aid, the solvent, and the additive(s) by a commonly used method using, for example, a mixing machine such as a planetary mixer, a ball mill, a blender mill, or a three-roll mill.

### Electrode for Electricity Storage Device

The electrode for an electricity storage device of the present disclosure includes the hardened product of the electrode slurry for an electricity storage device, described above, and a current collector. The hardened product of the electrode slurry for an electricity storage device is a hardened product obtained by removing the solvent from the electrode slurry for an electricity storage device by drying or the like.

The electrode for an electricity storage device of the present disclosure may be either a positive electrode or a negative electrode. The electrode of the present disclosure is superior in adhesiveness of the active material to the current collector. Thus, peel strength of the electrode (peel strength of the hardened product of the electrode slurry for an electricity storage device) before immersion in an electrolyte solution is preferably 300 N/m or more, more preferably 350) N/m or more, still more preferably 400 N/m or more, and may be yet more preferably 450) N/m or more. It is to be noted that the upper limit value of the peel strength of the electrode may be 1,000 N/m. When the peel strength of the electrode falls within the above range, the active material is less likely to peel from the current collector, and precipitation of lithium and the like and a short circuit during charging and discharging of the electrode can be inhibited. Furthermore, the peel strength falling within the above range is preferred due to the active material being more unlikely to peel from the current collector at a time of punching out or cutting the electrode.

The electrode for an electricity storage device of the present disclosure can be obtained by applying the electrode slurry for an electricity storage device of the present disclosure onto a current collector and removing the solvent by drying or the like. Furthermore, the electrode may be subjected to a rolling treatment after the drying.

The current collector is not particularly limited as long as it consists of a conductive material. Examples of the current collector include metal materials such as iron, copper, aluminum, nickel, stainless steel, titanium, tantalum, gold, platinum, and the like. These current collectors may be used alone of one type, or in combination of two or more types thereof. Of these current collectors, in view of adhesiveness with the active material and the discharge capacity, copper is preferred as a negative electrode current collector, while aluminum is preferred as a positive electrode current collector.

A method of applying the slurry onto the current collector is not particularly limited and, for example, an extrusion coater, a reverse roller, a doctor blade, an applicator, or the like may be employed. An amount of the slurry to be applied is selected as appropriate in accordance with a desired thickness of the hardened product derived from the electrode slurry for an electricity storage device.

Examples of a procedure for rolling the electrode for an electricity storage device of the present disclosure include procedures such as mold pressing, roll pressing, and the like. In light of increasing the capacity of the electricity storage device, the pressing pressure is preferably 1 MPa or more and 40 MPa or less.

In the electrode for an electricity storage device of the present disclosure, the thickness of the current collector is preferably 1 μm or more and 20 μm or less, and may be more preferably 2 μm or more and 15 μm or less. The thickness of the hardened product of the electrode slurry for an electricity storage device is preferably 10 μm or more and 400 μm or less, and may be more preferably 20 μm or more and 300 μm or less. The thickness of the electrode for an electricity storage device of the present disclosure is preferably 20 μm or more and 200 μm.

### Electricity Storage Device

The electricity storage device of the present disclosure includes the electrode for an electricity storage device, described above. The electrode for an electricity storage device in the electricity storage device may be either a negative electrode or a positive electrode, or may be both a negative electrode and a positive electrode.

The electricity storage device may be a battery: The electricity storage device is exemplified by a lithium ion secondary battery, a sodium ion secondary battery, a lithium-sulfur battery; an all-solid-state battery, a lithium ion capacitor, a lithium battery, a nickel-hydrogen battery, an alkaline dry-cell battery, and the like.

The electricity storage device may include an electrolyte solution. Here, the electrolyte solution means a solution resulting from dissolving an electrolyte in a solvent. The electrolyte may be in the form of a liquid or a gel as long as it is used in a typical electricity storage device, and any electrolyte that exhibits a function as a battery may be selected as appropriate in accordance with a type of the negative electrode active material and the positive electrode active material. As a specific electrolyte, for example, a well-known lithium salt can be suitably used, and examples thereof include LiClO₄, LiBF₆, LiPF₆, LiCF₃SO₃, LiCF₃CO₂, LiAsF₆, LiSbF₆, LiB₁₀Cl₁₀, LiAlCl₄, LiCl, LiBr, LiB(C₂H5)₄, CF₃SO₃Li, CH₃SO₃Li, LiCF₃SO₃, LiC₄F₉SO₃, Li(CF₃SO₂)₂N, lower aliphatic lithium carboxylate, and the like.

The solvent contained in the electrolyte solution is not particularly limited. Specific examples thereof include: carbonates such as propylene carbonate, ethylene carbonate, butylene carbonate, dimethyl carbonate, ethyl methyl carbonate, diethyl carbonate, and vinylene carbonate; lactones such as γ-butyl lactone; ethers such as trimethoxymethane, 1,2-dimethoxyethane, diethyl ether, 2-ethoxyethane, tetrahydrofuran, and 2-methyltetrahydrofuran; sulfoxides such as dimethyl sulfoxide; oxolanes such as 1,3-dioxolane and 4-methyl-1,3-dioxolane; nitrogen-containing compounds such as acetonitrile and nitromethane; organic acid esters such as methyl formate, methyl acetate, ethyl acetate, butyl acetate, methyl propionate, and ethyl propionate; inorganic acid esters such as triethyl phosphate, dimethyl carbonate, and diethyl carbonate; diglymes; triglymes; sulfolanes; oxazolidinones such as 3-methyl-2-oxazolidinone; sultones such as 1,3-propanesultone, 1,4-butanesultone, and naphthasultone; and the like. These solvents may be used alone of one type, or in combination of two or more types thereof. When an electrolyte solution in the form of a gel is used, a nitrile-based polymer, an acrylic polymer, a fluorine-based polymer, an alkylene oxide-based polymer, or the like can be added as a gelling agent.

In the case in which the electrode for an electricity storage device, described above, is used for either a positive electrode or a negative electrode in the electricity storage device, a commonly used electrode can be used an electrode for which the electrode for an electricity storage device of the present disclosure is not used (in other words, the electrode not containing the binder for an electricity storage device, described above).

In one preferred embodiment, the electricity storage device of the present disclosure includes the electrode for an electricity storage device of the present disclosure as a negative electrode, and includes a commonly used electrode as a positive electrode. In other words, in one preferred embodiment of the present disclosure, the electricity storage device includes a negative electrode containing the above-described binder for an electricity storage device, and a positive electrode not containing the above-described binder for an electricity storage device. In this case, the positive electrode is not particularly limited as long as it is a positive electrode that is typically used in an electricity storage device.

Alternatively, in another preferred embodiment, the electricity storage device of the present disclosure includes the electrode for an electricity storage device of the present disclosure as a positive electrode, and includes a commonly used electrode as a negative electrode. In other words, in one preferred embodiment of the present disclosure, the electricity storage device includes a positive electrode containing the above-described binder for an electricity storage device, and a negative electrode not containing the above-described binder for an electricity storage device. The negative electrode is not particularly limited as long as it is a negative electrode that is commonly used in an electricity storage device. In this case, it is preferred that: at the time of forming the electrode, the binder solution contained in the electrode slurry for an electricity storage device to be used is a binder solution containing the binder of the present disclosure and N-methyl-2-pyrrolidone (NMP). This is because when the solvent in the electrode slurry for an electricity storage device is NMP, deterioration of the positive electrode active material in the electrode slurry for an electricity storage device can be inhibited, and due to the characteristics of the above-described modified PVA contained in the binder, peel strength of the positive electrode can be enhanced.

Furthermore, both the positive electrode and the negative electrode may be the electrode for an electricity storage device of the present disclosure of the present disclosure. In other words, in one preferred embodiment of the present disclosure, the electricity storage device includes a positive electrode containing the above-described binder for an electricity storage device, and a negative electrode containing the above-described binder for an electricity storage device.

A method for producing the electricity storage device of the present disclosure is not particularly limited, and for example, in a case in which the electricity storage device is a battery; the battery can be produced in the following manner. Specifically, the method may be such that a negative electrode and a positive electrode are disposed on one another via a separator such as a polypropylene porous membrane, and then wound and/or folded, or the like according to the shape of the battery and then placed in a battery container, after which an electrolyte solution is injected thereinto and the battery container is sealed. The shape of the battery may be any well-known shape of, for example, a coin type, a button type, a sheet type, a cylindrical type, a square type, or a flat type.

The electricity storage device of the present disclosure is useful in various intended usages. For example, the electricity storage device is useful as a battery used in a mobile terminal that requires size reduction, thickness reduction, weight reduction, and performance enhancement. Furthermore, the electricity storage device can also be suitably used as a battery of a device that requires flexibility, such as a wound-type dry-cell battery or a laminated-type battery.

### EXAMPLES

Hereinafter, the present invention is explained in detail by way of Examples, but the present invention is not in any way limited to these Examples. Unless otherwise specified particularly, “%” in EXAMPLES pertains to mass. First, measurement methods and evaluation methods are described below. It is to be noted that the physical property values (or evaluation values) described herein are based on values determined by the following methods.

Measurements of the physical property values of each PVA used in the below-described Examples and Comparative Examples, evaluation in electrode application, and evaluation in battery application were performed in accordance with the following methods.

### Viscosity-Average Degree of Polymerization of PVA

The viscosity-average degree of polymerization of the modified PVA and the PVA (E) was determined in accordance with JIS K 6726 (1994). Specifically, in a case of the modified PVA having a degree of saponification of less than 99.5 mol %, saponification was conducted to give the degree of saponification of 99.5 mol % or more, and the viscosity-average degree of polymerization (P) was determined by the following formula using a limiting viscosity [η] (liters/g) measured in water at 30° C., for the modified PVA or the PVA (E) obtained.

$$P = {( [ η ] \times 1 {0}^{4} / 8.29 )}^{( 1 / 0.62 )}$$

### Degree of Saponification of PVA

The degree of saponification of the modified PVA and the PVA (E) was determined in accordance with a procedure in JIS K 6726 (1994).

### Degree of Modification (X)

The content (X) (degree of modification (X)) of the structural unit derived from the ethylenic unsaturated dicarboxylic acid derivative (A) in the modified PVA was determined from a spectrum of the modifying species by means of ¹H-NMR spectral analysis. Furthermore, the degree of modification (X) of the PVA (E) was determined by a similar procedure.

### Degree of Modification (Y)

The content (Y) (degree of modification (Y)) of the structural unit represented by the formula (I) in the modified PVA was determined from a spectrum detected at 6.8 to 7.2 ppm in ¹H-NMR spectral analysis, measured in a dimethylsulfoxide solvent. Furthermore, Y/X, being a ratio of the degree of modification (Y) to the degree of modification (X), was determined.

Amount of Insoluble Content when Aqueous Solution at 90° C. Having Concentration of 5% by Mass is Prepared (Amount of Water-Insoluble Content)

A 500 mL flask equipped with an agitator and a reflux condenser was placed in a water bath set to 20° C. After charging 285 g of distilled water into the flask, stirring was started at 300 rpm. Fifteen grams of a modified PVA powder was weighed out, and the modified PVA powder was gradually charged into the flask. When an entirety of the modified PVA powder (15 g) was charged into the flask, the modified PVA powder was dissolved by immediately elevating a temperature of the water bath to 90° C. over a time period of about 30 min to give a solution of the modified PVA. After the temperature of the water bath reached 90° C. the dissolution was continued while further stirring for 60 min at 300 rpm. Thereafter, the modified PVA solution was used to filter out undissolved, residual particles (undissolved particles) with a metal filter having a mesh opening size of 63 μm. Next, the filter was washed with hot water at 90° C. to remove the solution attached to the filter to retain only the dissolved particles on the filter, and then the filter was dried for 1 hour with a heating dryer at 120° C. A mass of the filter after the drying and a mass of the filter before being used for the filtering were compared to calculate a mass of the undissolved particles. A mass proportion of the undissolved particles with respect to the total amount of the modified PVA used in preparing the modified PVA solution was defined as the amount of insoluble content (amount of water-insoluble content) when the modified PVA was prepared into an aqueous solution at 90° C. having a concentration of 5% by mass.

### Particle Size Distribution

A particle size distribution of the modified PVA powder was measured by a dry sieve procedure disclosed in JIS Z 8815 (1994). The modified PVA powder was sieved through a sieve (filter) having a mesh opening size of 1.00 mm, and a mass of the modified PVA powder having passed through the sieve was measured. A proportion (% by mass) of the modified PVA particles having passed through the sieve was then calculated from the mass of the modified PVA powder before sieving. Similarly, separately and independently from the sieve having the mesh opening size of 1.00 mm, the modified PVA powder was sieved through a sieve (filter) having a mesh opening size of 500 μm, and a mass of the modified PVA powder having passed through the sieve was measured. A proportion (% by mass) of the modified PVA particles having passed through the sieve was then calculated from the mass of the modified PVA powder before sieving. It is to be noted that the mesh opening sizes conform to the nominal mesh opening sizes W disclosed in JIS Z 8801-1 (2006).

### Evaluation of Peel Strength (N/m)

For each lithium ion secondary battery negative electrode produced in the below-described Examples and Comparative Examples, the strength when peeling a hardened product (a portion derived from the negative electrode slurry prepared in each of the Examples and the Comparative Examples) from a copper foil serving as a current collector was measured. Specifically, a stainless steel plate and each negative electrode slurry-coated surface of each lithium ion secondary battery negative electrode obtained were pasted together using double-sided adhesive tape (manufactured by Nichiban Co., Ltd.), and the 180° peel strength (peeling width: 10 mm, peeling speed: 100 mm/min) was measured using a 50 N load cell (manufactured by IMADA Co., Ltd.).

### Evaluations of Initial Charge-Discharge Efficiency (%) and Direct-Current Resistance (Ω)

For each lithium ion secondary battery (coin battery) produced in the below-described Examples and Comparative Examples, a test was conducted using a commercially available charge-discharge tester (TOSCAT-3100, manufactured by Toyo System Co., Ltd.). A resistance value measured when a current of 0.1 mA was applied for 3 seconds after initial charging was defined as the direct-current resistance. In the charging, charging was performed at a constant current of 0.2 C (1 to 1.2 mA) up to 0.01 V with respect to the lithium potential, and furthermore, charging was performed at a constant voltage of 0.01 V with respect to the lithium potential up to a current of 0.02 mA. In the discharging, discharging was performed at a constant current of 0.2 C (1 to 1.2 mA) down to 1.5 V with respect to the lithium potential. The lithium ion secondary battery was placed in a 25° C. thermostat chamber and subjected to initial charging and discharging under the above-described conditions, and the specific charge capacity (mAh/g), the specific discharge capacity (mAh/g), and the direct-current resistance (Ω) were measured. The initial charge-discharge efficiency (%) was calculated using the following formula:

$$( specific discharge capacity ) / ( specific charge capacity ) \times 100.$$

### Evaluation of Charge Capacity Retention Rate at 0.5 C

For each lithium ion secondary battery (coin battery) produced in the below-described Examples and Comparative Examples, a rate test was conducted following the above-described initial charge/discharge using a commercially available charge-discharge tester (TOSCAT-3100, manufactured by Toyo System Co., Ltd.). In the charging, charging was performed at a constant current of 0.5 C (2.5 to 3.0 mA) up to 0 V with respect to the lithium potential. In the discharging, discharging was performed at a constant current of 0.2 C (1 to 1.2 mA) down to 1.5 V with respect to the lithium potential. The lithium ion secondary battery was placed in a 25° C. thermostat chamber and subjected to charging and discharging under the above-described conditions. The cell-charging capacity (mAh) at this time was measured. The charge capacity retention rate (%) at 0.5 C was calculated using the following formula:

$$( specific charge capacity ( mAh / g ) at 0.5 C ) / \\ ( specific charge capacity ( mAh / g ) at 0.2 C ) \times 100.$$

### Evaluation of Number of Breakage Occurrences (Units)

From each of the negative electrodes for a lithium ion secondary battery produced in the below-described Examples and Comparative Examples, 10 electrodes were punched out using a punching machine with a 14 mm diameter, and the number of the electrodes in which the active material had detached from the current collector was counted.

### Production of Modified PVA

### Production Example 1

### PVA-1

Into a reactor equipped with a stirrer, a reflux condenser, a nitrogen inlet tube, a comonomer dripping port, and a polymerization initiator addition port. 970 parts by mass of vinyl acetate and 30 parts by mass of methanol were charged, and nitrogen substitution in the system was carried out for 30 min while bubbling nitrogen. Further, monomethyl maleate was selected as the ethylenic unsaturated dicarboxylic acid derivative (A), serving as the modifying species, and nitrogen substitution in a methanol solution of monomethyl maleate (concentration: 2%) was carried out by bubbling nitrogen gas. Elevation of the temperature in the reactor was started, and when the internal temperature became 60° C. 0.1 parts by mass of 2,2′-azobisisobutyronitrile (AIBN) were added thereto to start the polymerization. To the reactor was added the methanol solution of monomethyl maleate dropwise, and the polymerization was allowed at 60° C. for 2 hrs while the monomer composition ratio in the polymerization solution was maintained to be constant. Thereafter, the mixture was cooled to stop the polymerization. The total amount of the ethylenic unsaturated dicarboxylic acid derivative (A) added until the polymerization was stopped was 1.4 parts by mass, and the conversion (rate of polymerization) when the polymerization was stopped was 20%. Subsequently, unreacted monomers were removed while adding methanol at intervals at 30° C. under a reduced pressure to obtain a methanol solution of the vinyl ester polymer (concentration: 30%). Next, methanol was further added to this methanol solution to prepare 666.7 parts by mass of the methanol solution of the vinyl ester polymer (the polymer in the solution: 200.0 parts by mass), 14.8 parts by mass of a 10% methanol solution of sodium hydroxide were added thereto, and saponification was allowed at 40° C. The polymer concentration of the saponification solution was 15%, and the molar ratio of sodium hydroxide to the vinyl acetate unit in the polymer was 0.016. Since a gelatinous material was produced about 20 min after the addition of the methanol solution of sodium hydroxide, this gelatinous matter was ground with a grinder and further left to stand at 40° C. for 1 hour to allow the saponification to proceed. Thereafter, 500 parts by mass of methyl acetate were added to neutralize remaining alkali. After completion of neutralization was ascertained by using a phenolphthalein indicator, the mixture was filtered off to obtain a white solid. To this white solid were added 2,000 parts by mass of a mixed solution having a volume ratio of methanol to methyl acetate being 20:80, and the resulting mixture was left to stand at room temperature for 3 hrs and washing was permitted. After the washing operation was performed three times, a white solid obtained by deliquoring through centrifugation was dried by a heat treatment at 95° C. for 4 hrs with a dryer, and a modified PVA powder (PVA-1) thus obtained was defined as a binder for an electricity storage device. Various production materials and the like of PVA-1, as well as physical properties thereof, are shown together in Table 1.

### Examples 2 to 9

### (PVA-2 to PVA-9)

Each modified PVA (PVA-2 to PVA-9), being a binder for an electricity storage device, was produced by a production method similar to that of PVA-1 (Production Example 1), except that the polymerization conditions such as the charging amounts of vinyl acetate and methanol, the type and amount of addition of the modifying species (the ethylenic unsaturated dicarboxylic acid derivative (A)) used at the time of polymerization, and the conversion, as well as the saponification conditions such as the molar ratio of sodium hydroxide, were changed as shown in Table 1. The physical properties of each modified PVA are shown together in Table 1.

### Production of PVA (E)

### Production Examples 10 to 13

### (PVA-10 to PVA-13)

Each PVA (E) (PVA-10 to PVA-13) was produced by a production method similar to that of PVA-1 (Production Example 1), except that the polymerization conditions such as the charging amounts of vinyl acetate and methanol, the type and amount of addition of the modifying species (the ethylenic unsaturated dicarboxylic acid derivative (A)) used at the time of polymerization, and the conversion, as well as the saponification conditions such as the molar ratio of sodium hydroxide, were changed as shown in Table 2. The physical properties of each PVA (E) are shown together in Table 2.

TABLE 1

| | | | | | | | | | Washing | |
|---|---|---|---|---|---|---|---|---|---|---|
| | | | | | | | | | washing | |
| | | | | | | | | | liquid | |
| | | | | | | | | | constitution | |
| | | Polymerization | | | | | | | methanol/ | |
| | | vinyl | | modifying | | | Saponification | | methyl | Drying |
| | | acetate | methanol | species | | | PVAc | NaOH | acetate | resin |
| | Modified | (parts by | (parts by | | (parts by | conversion | concentration | (molar | (volume | temperature |
| | PVA | mass) | mass) | type¹⁾ | mass) | (%) | (%) | ratio) | ratio) | (° C.) |
| Production | PVA-1 | 970 | 30 | MMM | 1.4 | 20 | 15 | 0.016 | 20/80 | 95 |
| Example 1 | | | | | | | | | | |
| Production | PVA-2 | 970 | 30 | MMM | 1.4 | 20 | 15 | 0.013 | 20/80 | 95 |
| Example 2 | | | | | | | | | | |
| Production | PVA-3 | 970 | 30 | MMM | 1.4 | 20 | 15 | 0.04 | 20/80 | 95 |
| Example 3 | | | | | | | | | | |
| Production | PVA-4 | 970 | 30 | MMM | 1.4 | 20 | 15 | 0.016 | 20/80 | 125 |
| Example 4 | | | | | | | | | | |
| Production | PVA-5 | 920 | 80 | MMM | 0.04 | 20 | 15 | 0.01 | 20/80 | 95 |
| Example 5 | | | | | | | | | | |
| Production | PVA-6 | 400 | 600 | MMM | 1.65 | 40 | 25 | 0.02 | 20/80 | 95 |
| Example 6 | | | | | | | | | | |
| Production | PVA-7 | 800 | 200 | MMM | 1.76 | 30 | 20 | 0.01 | 20/80 | 95 |
| Example 7 | | | | | | | | | | |
| Production | PVA-8 | 970 | 30 | DMM | 1.69 | 20 | 15 | 0.017 | 20/80 | 95 |
| Example 8 | | | | | | | | | | |
| Production | PVA-9 | 970 | 30 | MA | 1.05 | 20 | 15 | 0.016 | 20/80 | 95 |
| Example 9 | | | | | | | | | | |

| | | Modified PVA analysis values | | | | | | | |
|---|---|---|---|---|---|---|---|---|---|
| | | | | | | | | particle size | |
| | | | | | | | | distribution | |
| | | | | | | | | passed | passed |
| | | | | | | | | through | through |
| | | | | | | | | mesh | mesh |
| | Drying | | | | | | amount of | opening | opening |
| | drying | | | degree of | degree of | | water- | size of | size of |
| | time | degree of | degree of | modification | modification | (Y)/ | insoluble | 1.00 mm | 500 μm |
| | period | polymerization | saponification | (X) | (Y) | (X) | content | (% by | (% by |
| | (hr) | — | (mol %) | (mol %) | (mol %) | — | (ppm) | mass) | mass) |
| Production | 4 | 3,200 | 88.0 | 0.35 | 0.06 | 0.17 | 30 | 99 | 56 |
| Example 1 | | | | | | | | | |
| Production | 4 | 3,200 | 82.0 | 0.35 | 0.05 | 0.14 | 150 | 99 | 56 |
| Example 2 | | | | | | | | | |
| Production | 4 | 3,200 | 98.5 | 0.35 | 0.07 | 0.20 | 20 | 99 | 56 |
| Example 3 | | | | | | | | | |
| Production | 8 | 3,200 | 88.0 | 0.35 | 0.01 | 0.03 | 2,500 | 99 | 56 |
| Example 4 | | | | | | | | | |
| Production | 4 | 3,200 | 88.0 | 0.02 | 0.001 | 0.05 | 500 | 99 | 56 |
| Example 5 | | | | | | | | | |
| Production | 4 | 600 | 88.0 | 0.6 | 0.12 | 0.20 | 50 | 99 | 56 |
| Example 6 | | | | | | | | | |
| Production | 4 | 1,800 | 65.0 | 0.4 | 0.02 | 0.05 | 1,200 | 99 | 56 |
| Example 7 | | | | | | | | | |
| Production | 4 | 3,200 | 88.0 | 0.35 | 0.08 | 0.23 | 40 | 99 | 56 |
| Example 8 | | | | | | | | | |
| Production | 4 | 3,200 | 88.0 | 0.35 | 0.08 | 0.23 | 60 | 99 | 56 |
| Example 9 | | | | | | | | | |

¹⁾MMM: monomethyl maleate DMM: dimethyl maleate MA: maleic anhydride

TABLE 2

| | | | | | | | | | PVA (E) analysis values | | |
|---|---|---|---|---|---|---|---|---|---|---|---|
| | | Polymerization | | | | | Saponification | | | | degree of |
| | | vinyl | | | | | PVAc | | degree of | degree of | modifi- |
| | | acetate | methanol | modifying species | | con- | concen- | NaOH | polymer- | saponifi- | cation |
| | | (parts | (parts | | (parts | version | tration | (molar | ization | cation | (X) |
| | PVA (E) | by mass) | by mass) | type²⁾ | by mass) | (%) | (%) | ratio) | — | (mol %) | (mol %) |
| Production Example 10 | PVA-10 | 650 | 350 | MMM | 14.5 | 30 | 20 | 0.076 | 1,200 | 90 | 4 |
| Production Example 11 | PVA-11 | 650 | 350 | MMM | 14.5 | 30 | 20 | 0.14 | 1,200 | 98.5 | 4 |
| Production Example 12 | PVA-12 | 750 | 250 | MMM | 4.13 | 30 | 20 | 0.046 | 1,800 | 88 | 1 |
| Production Example 13 | PVA-13 | 400 | 600 | MMM | 5.52 | 40 | 20 | 0.043 | 500 | 88 | 1 |

²⁾MMM: monomethyl maleate

### Example 1

Hereinafter, an Example in which the PVA-1, produced as described above, was used to produce an electricity storage device is shown.

### Production of Binder for Electricity Storage Device

The PVA-1 was used as the binder.

### Preparation of Binder Solution for Electricity Storage Device

A binder solution having a solid content concentration of about 10% by mass was obtained by adding water to the binder (the PVA-1) and mixing with heating at 80° C. for 1 hour.

### Preparation of Electrode Slurry for Electricity Storage Device (Negative Electrode Slurry)

A negative electrode slurry was prepared by charging the above-described binder solution having the solid content concentration of 10% by mass, artificial graphite (FSN-1, manufactured by Shanghai Shanshan Technology), Super-P (manufactured by TIMCAL Ltd.) as a conductive aid (conductivity-imparting agent), and CMC (CMC Daicel 2200, manufactured by Daicel Miraizu Ltd.) as a thickening agent into a dedicated container and kneading these materials using a planetary mixer (ARE-250, manufactured by THINKY Corporation). The charging was performed such that, as a proportion of each component in the negative electrode slurry, there were 96 parts by mass of the artificial graphite, 1 part by mass of the Super-P, 1.5 parts by mass of solid content (in other words, the binder) in the binder solution, and 1.5 parts by mass of CMC. In other words, the composition ratio of the negative electrode active material, the conductive aid, the binder, and the thickening agent in the negative electrode slurry was, in terms of solid content, negative electrode active material:conductive aid:binder:thickening agent=96:1:1.5:1.5 (mass ratio).

### Production of Electrode for Electricity Storage Device (Negative Electrode for Lithium Ion Secondary Battery)

The negative electrode slurry obtained as described above was applied onto a current collector, being a copper foil (CST8G, manufactured by Fukuda metal Foil & Powder Co., Ltd.), using a bar coater (T101, manufactured by Matsuo Sangyo Co., Ltd.). This current collector was subjected to primary drying at 80° C. over 30 min in a hot air dryer and then a rolling process using a roll press (manufactured by Hohsen Corp.). Subsequently, the thus rolled current collector was punched out as a battery electrode (ø14 mm), which was then subjected to secondary drying at 140° C. over 3 hrs under reduced pressure to produce a negative electrode for a lithium ion secondary battery (negative electrode for a coin battery). A total of 10ø14 mm punched-out electrodes were produced, and the number of broken electrodes was counted. It is to be noted that an unbroken negative electrode was selected as the negative electrode to be used in the lithium ion secondary battery (coin battery). The peel strength of the thus produced negative electrode for a lithium ion secondary battery was measured by the above-described method. The results thereof are shown together in Table 3.

### Production of Electricity Storage Device (Lithium Ion Secondary Battery)

The negative electrode for a lithium ion secondary battery obtained as described above was transferred to a glove box (manufactured by Miwa Manufacturing Co., Ltd.) in an argon gas atmosphere. A lithium metal foil (0.2 mm in thickness, ø16 mm) was used as a counter electrode and a polypropylene film (CELGARD #2400, manufactured by Polypore International, Inc.) was used as a separator, and a mixed solvent system (1M-LiPF₆, EC/EMC=3/7% by volume, VC=2% by mass) (manufactured by Tomiyama Pure Chemical Industries, Ltd.) obtained by adding lithium hexafluorophosphate (LiPF₆) to a mixed solvent of ethylene carbonate (EC) and ethyl methyl carbonate (EMC), and then adding vinylene carbonate (VC) was injected as an electrolyte solution. A coin battery (2032-type), serving as the lithium ion secondary battery, was produced according to this configuration. The thus obtained coin battery was subjected to measurements of the initial charge-discharge efficiency when charging-discharging at 0.2 C, the direct-current resistance, and the charge capacity when charging-discharging at 0.5 C by the above-described methods. The results are shown together in Table 3.

### Examples 2 to 6, Comparative Examples 1 to 3

Production of a binder, preparation of a binder solution, preparation of a negative electrode slurry, production of a negative electrode for a lithium ion secondary battery, and production of a lithium ion secondary battery were performed by procedures similar to those of Example 1, except that PVA-2 to PVA-9 were respectively used instead of the PVA-1, and the same measurements and evaluations were performed. The results are shown together in Table 3.

### Example 7

Preparation of a binder solution, preparation of a negative electrode slurry, production of a negative electrode for a lithium ion secondary battery, and production of a lithium ion secondary battery were performed by procedures similar to those of Example 1, except that a binder was produced by using 1.0 part by mass of the PVA-1 and 0.5 parts by mass of the PVA-10, and the same measurements and evaluations were performed. The results are shown together in Table 3.

### Examples 8 to 10

Preparation of a binder solution, preparation of a negative electrode slurry, production of a negative electrode for a lithium ion secondary battery; and production of a lithium ion secondary battery were performed by procedures similar to those of Example 7, except that 0.5 parts by mass of the PVA-11 to the PVA-13, respectively, were used instead of the PVA-10, and the same measurements and evaluations were performed. The results are shown together in Table 3.

### Example 11

A binder solution was prepared by: adding lithium acetate, as the water-soluble Li salt, to a solution having a solid content concentration of about 10% by mass, prepared by adding water to the PVA-1 and mixing with heating at 80° C. for 1 hour; and then mixing the solution by dissolving with stirring such that a mass ratio of the PVA-1 to lithium acetate was the ratio 90:10. Preparation of a negative electrode slurry, production of a negative electrode for a lithium ion secondary battery, and production of a lithium ion secondary battery were performed by procedures similar to those of Example 1, except that the binder solution in which PVA-1:lithium acetate=90:10 was used, and the same measurements and evaluations were performed. It is to be noted that in this case, in terms of solid content, the compositional ratio of the compositions contained in the negative electrode slurry, being the negative electrode active material, the conductive aid, the binder (the mixture of the PVA-1 and the water-soluble Li salt), and the thickening agent, was negative electrode active material:conductive aid:PVA-1:water-soluble Li salt:thickening agent=96:1:1.35:0.15:1.5 (mass ratio). The results are shown together in Table 3.

### Example 12

Preparation of a negative electrode slurry, production of a negative electrode for a lithium ion secondary battery, and production of a lithium ion secondary battery were performed by procedures similar to those of Example 11, except that a binder solution in which PVA-1:lithium acetate:PVA-10=90:10:50 was prepared, and the same measurements and evaluations were performed. The results are shown together in Table 3.

### Example 13

Preparation of a negative electrode slurry, production of a negative electrode for a lithium ion secondary battery, and production of a lithium ion secondary battery were performed by procedures similar to those of Example 11, except that a binder solution in which PVA-1:lithium acetate:PVA-10=80:20:50 was prepared, and the same measurements and evaluations were performed. The results are shown together in Table 3.

### Examples 14 to 26

Preparation of a binder solution for an electricity storage device, preparation of a negative electrode slurry, production of a negative electrode for a lithium ion secondary battery, and production of a lithium ion secondary battery were performed by procedures similar to those of Example 11, except that usage amounts of the PVA-1 and each water-soluble Li salt were changed as shown in Table 3, and the same measurements and evaluations were performed. The results are shown together in Table 3. It is to be noted that in Table 3, LiOAc represents lithium acetate, LiOH represents lithium hydroxide, LiCl represents lithium chloride, Li₂SO₄ represents lithium sulfate, LiFSI represents lithium bis(fluorosulfonyl)imide, and Li₂CO₃ represents lithium carbonate.

### Example 27

Preparation of a binder solution for an electricity storage device, preparation of a negative electrode slurry, production of a negative electrode for a lithium ion secondary battery, and production of a lithium ion secondary battery were performed by procedures similar to those of Example 1, except that as a binder, 3 parts by mass of the PVA-1 were used and CMC was not used, and the same measurements and evaluations were performed. The results are shown together in Table 3.

### Example 28

Production of a negative electrode for a lithium ion secondary battery and production of a lithium ion secondary battery were performed by procedures similar to those of Example 11, except that the water-soluble Li salt (lithium acetate) was charged not as a binder solution, but as a powder, i.e., a negative electrode slurry was prepared by charging the binder solution of Example 1, lithium acetate (powder), artificial graphite (FSN-1, manufactured by Shanghai Shanshan Technology) as the negative electrode active material, Super-P (manufactured by TIMCAL Ltd.) as the conductive aid (conductivity-imparting agent), and CMC (CMC Daicel 2200, manufactured by Daicel Miraizu Ltd.) as the thickening agent into a dedicated container and kneading using a planetary mixer (ARE-250, manufactured by THINKY Corporation), and the same measurements and evaluations were performed. The results are shown together in Table 3.

TABLE 3

| | | | | | | | | Evaluations | | | | |
|---|---|---|---|---|---|---|---|---|---|---|---|---|
| | Negative electrode slurry formulation (with respect to graphite being | | | | | | | | | charge | | |
| | 96, conductive aid being 1, and CMC being 1.5) | | | | | | | | | capacity | | |
| | | | | | | | modified | | initial | retention | direct- | number of |
| | modified PVA | | PVA (E) | | water-soluble Li salt | | PVA/water- | peel | charge- | rate at | current | breakage |
| | | usage | | usage | | usage | soluble | strength | discharge | 0.5 C | resistance | occurrences |
| | type | amount | type | amount | type | amount | Li salt | (N/m) | efficiency | (%) | (Ω) | (units) |
| Example 1 | PVA-1 | 1.5 | — | — | — | — | — | 435 | 97.7 | 76.2 | 191 | 0 |
| Example 2 | PVA-2 | 1.5 | — | — | — | — | — | 378 | 97.4 | 76.7 | 186 | 0 |
| Example 3 | PVA-3 | 1.5 | — | — | — | — | — | 382 | 95.8 | 68.5 | 172 | 0 |
| Comparative | PVA-4 | 1.5 | — | — | — | — | — | 118 | 87.3 | 35.7 | 454 | 6 |
| Example 1 | | | | | | | | | | | | |
| Comparative | PVA-5 | 1.5 | — | — | — | — | — | 219 | 88.8 | 69.2 | 195 | 7 |
| Example 2 | | | | | | | | | | | | |
| Example 4 | PVA-6 | 1.5 | — | — | — | — | — | 315 | 94.3 | 74.8 | 161 | 0 |
| Comparative | PVA-7 | 1.5 | — | — | — | — | — | 141 | 89.2 | 40.6 | 355 | 5 |
| Example 3 | | | | | | | | | | | | |
| Example 5 | PVA-8 | 1.5 | — | — | — | — | — | 406 | 98.2 | 72.1 | 170 | 0 |
| Example 6 | PVA-9 | 1.5 | — | — | — | — | — | 412 | 97.0 | 74.9 | 190 | 0 |
| Example 7 | PVA-1 | 1 | PVA-10 | 0.5 | — | — | — | 520 | 98.6 | 78.4 | 182 | 0 |
| Example 8 | PVA-1 | 1 | PVA-11 | 0.5 | — | — | — | 652 | 98.6 | 68.6 | 293 | 0 |
| Example 9 | PVA-1 | 1 | PVA-12 | 0.5 | — | — | — | 577 | 97.5 | 72.7 | 188 | 0 |
| Example 10 | PVA-1 | 1 | PVA-13 | 0.5 | — | — | — | 404 | 96.6 | 71.4 | 196 | 0 |
| Example 11 | PVA-1 | 1.35 | — | — | LiOAc | 0.15 | 90/10 | 424 | 96.0 | 83.3 | 146 | 0 |
| Example 12 | PVA-1 | 0.9 | PVA-10 | 0.5 | LiOAc | 0.10 | 90/10 | 492 | 95.8 | 84.3 | 122 | 0 |
| Example 13 | PVA-1 | 0.8 | PVA-10 | 0.5 | LiOAc | 0.20 | 80/20 | 468 | 96.0 | 86.1 | 110 | 0 |
| Example 14 | PVA-1 | 1.485 | — | — | LiOAc | 0.015 | 99/1 | 443 | 96.7 | 77.5 | 195 | 0 |
| Example 15 | PVA-1 | 1.425 | — | — | LiOAc | 0.075 | 95/5 | 441 | 97.3 | 82.5 | 147 | 0 |
| Example 16 | PVA-1 | 1.275 | — | — | LiOAc | 0.225 | 85/15 | 424 | 96.3 | 85.7 | 137 | 0 |
| Example 17 | PVA-1 | 1.2 | — | — | LiOAc | 0.3 | 80/20 | 387 | 95.6 | 86.7 | 105 | 0 |
| Example 18 | PVA-1 | 1.05 | — | — | LiOAc | 0.45 | 70/30 | 321 | 96.8 | 83.2 | 158 | 0 |
| Example 19 | PVA-1 | 1.35 | — | — | LiOH | 0.15 | 90/10 | 439 | 96.5 | 85.2 | 127 | 0 |
| Example 20 | PVA-1 | 1.2 | — | — | LiOH | 0.3 | 80/20 | 307 | 95.6 | 87.6 | 107 | 0 |
| Example 21 | PVA-1 | 1.35 | — | — | LiCl | 0.15 | 90/10 | 373 | 96.0 | 85.2 | 126 | 0 |
| Example 22 | PVA-1 | 1.35 | — | — | Li₂SO₄ | 0.15 | 90/10 | 388 | 95.3 | 80.7 | 136 | 0 |
| Example 23 | PVA-1 | 1.35 | — | — | LiFSI | 0.15 | 90/10 | 403 | 95.7 | 82.3 | 140 | 0 |
| Example 24 | PVA-1 | 1.35 | — | — | lithium | 0.15 | 90/10 | 420 | 96.6 | 81.9 | 135 | 0 |
| | | | | | maleate | | | | | | | |
| Example 25 | PVA-1 | 1.35 | — | — | lithium | 0.15 | 90/10 | 427 | 96.6 | 81.5 | 145 | 0 |
| | | | | | formate | | | | | | | |
| Example 26 | PVA-1 | 1.35 | — | — | Li₂CO₃ | 0.15 | 90/10 | 419 | 94.6 | 80.7 | 148 | 0 |
| Example 27³⁾ | PVA-1 | 3 | — | — | — | — | — | 423 | 96.7 | 76.2 | 193 | 0 |
| Example 28 | PVA-1 | 1.35 | — | — | LiOAc | 0.15 | 90/10 | 389 | 97.2 | 75.1 | 187 | 0 |

³⁾Negative electrode slurry formulation with respect to graphite being 96 and conductive aid being 1.

As shown in Table 3 above, each electrode for an electricity storage device and electricity storage device of the Examples was superior in peel strength, initial charge-discharge efficiency, the charge capacity retention rate at 0.5 C, direct-current resistance, and the number of breakage occurrences. It is to be noted that among the Examples in which the water-soluble Li salt was not used, while Example 8 exhibited the highest peel strength, the direct-current resistance thereof had a comparatively high value. Furthermore, in a case of comparing Example 1 and Example 4, which differ only in the type of the modified PVA, Example 4, exhibiting a peel strength being lower by about 30%, had a lower direct-current resistance value. This reveals that the peel strength being high and the direct-current resistance being low are not necessarily correlated.

Furthermore, in the PVA-10 to the PVA-13, which were used in the Examples, respective amounts of water-insoluble content were not measured. Here, Examples 7 to 10, in which the PVA-1 and one of the PVA-10 to the PVA-13 were respectively used, each had peel strength and direct-current resistance being about equally favorable to that of Example 1, in which only the PVA-1 was used. Furthermore, the PVA-10 to the PVA-13 were each produced by employing drying conditions similar to those of the PVA-1 and the like. Based on such performance and production procedures, it is highly likely that the amount of water-insoluble content of each of the PVA-10 to the PVA-13 is 0.1 ppm or more and less than 2,000 ppm.

1. A binder for an electricity storage device, the binder comprising a modified vinyl alcohol polymer,
wherein the modified vinyl alcohol polymer has:
a content of a structural unit derived from an ethylenic unsaturated dicarboxylic acid derivative (A) being 0.05 mol % or more and 10 mol % or less,
a degree of saponification of 70.0 mol % or more and 99.9 mol % or less, and
an amount of insoluble content being 0.1 ppm or more and less than 2,000 ppm, when the modified vinyl alcohol polymer is prepared into an aqueous solution at 90° C. having a concentration of 5% by mass.

2. The binder for an electricity storage device according to claim 1, wherein the ethylenic unsaturated dicarboxylic acid derivative (A) is at least one selected from the group consisting of an ethylenic unsaturated dicarboxylic acid monoester, an ethylenic unsaturated dicarboxylic acid diester, and an ethylenic unsaturated dicarboxylic acid anhydride.

3. The binder for an electricity storage device according to claim 1, wherein the ethylenic unsaturated dicarboxylic acid derivative (A) is at least one selected from the group consisting of a maleic acid monoalkyl ester, a maleic acid dialkyl ester, maleic anhydride, a fumaric acid monoalkyl ester, and a fumaric acid dialkyl ester.

4. The binder for an electricity storage device according claim 1, wherein
at least a part of the structural unit derived from the ethylenic unsaturated dicarboxylic acid derivative (A) constitutes a part of a structural unit represented by the following formula (I), and
the modified vinyl alcohol polymer satisfies the following inequality (Q): 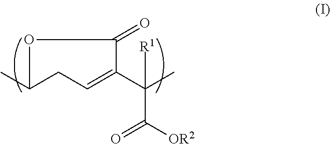
wherein, in the formula (I),
R¹ represents a hydrogen atom, or a linear or branched alkyl group having 1 to 8 carbon atoms, and
R² represents a metal atom, a hydrogen atom, or a linear or branched alkyl group having 1 to 8 carbon atoms, and
$$0. 05 ≦ \frac{Y}{X} < 0.98 \qquad ( Q )$$
in the inequality (Q),
X represents a content (mol %) of the structural unit derived from the ethylenic unsaturated dicarboxylic acid derivative (A), and
Y represents a content (mol %) of the structural unit represented by the formula (I).

5. The binder for an electricity storage device according to claim 1, wherein
the modified vinyl alcohol polymer is in a powder form, and
an amount of the modified vinyl alcohol polymer capable of passing through a sieve having a mesh opening size of 1.00 mm is 95% by mass or more with respect to an entirety of the modified vinyl alcohol polymer.

6. The binder for an electricity storage device according to claim 1, wherein
the modified vinyl alcohol polymer is in a powder form, and
an amount of the modified vinyl alcohol polymer capable of passing through a sieve having a mesh opening size of 500 μm is 30% by mass or more with respect to an entirety of the modified vinyl alcohol polymer.

7. The binder for an electricity storage device according to claim 1, wherein the modified vinyl alcohol polymer is a modified vinyl alcohol polymer comprising a crosslinked structure.

8. The binder for an electricity storage device according to claim 1, further comprising a water-soluble Li salt, wherein
a mass ratio of the modified vinyl alcohol polymer to the water-soluble Li salt is 70:30 to 95:5.

9. The binder for an electricity storage device according to claim 8, wherein a solubility of the water-soluble Li salt in water at 20° C. is 10 g/100 ml or more.

10. The binder for an electricity storage device according to claim 8, wherein a molecular weight of the water-soluble Li salt is 1,000 or less.

11. The binder for an electricity storage device according to claim 8, wherein the water-soluble Li salt is at least one selected from the group consisting of lithium chloride, lithium acetate, lithium formate, lithium hydroxide, lithium sulfate, lithium carbonate, lithium maleate, lithium oxalate, lithium citrate, lithium bis(trifluoromethanesulfonyl)imide, and lithium bis(fluorosulfonyl)imide.

12. A binder solution for an electricity storage device, the binder solution comprising:
the binder for an electricity storage device according to claim 1; and
a solvent.

13. An electrode slurry for an electricity storage device, the electrode slurry comprising:
the binder solution for an electricity storage device according to claim 12; and
an active material.

14. The electrode slurry for an electricity storage device according to claim 13, wherein a content of the binder for an electricity storage device with respect to 100 parts by mass of the active material is 0.1 parts by mass or more and 20 parts by mass or less.

15. An electrode for an electricity storage device, the electrode comprising:
a hardened product of the electrode slurry for an electricity storage device according to claim 13; and
a current collector.

16. An electricity storage device comprising the electrode for an electricity storage device according to claim 15.
